(19) United States
(12) Patent Application Publication
(10) Pub. No.: US 2024/0393167 A1
(43) Pub. Date: Nov. 28, 2024

(54) NOISE POINT FAULT DIAGNOSIS METHOD AND FAULT DIAGNOSIS SYSTEM

(71) Applicants: Hyundai Motor Company, Seoul (KR); Kia Corporation, Seoul (KR); Gwangju Institute of Science and Technology, Gwangju (KR)

(72) Inventors: Kyung Woo Lee, Seoul (KR); Yong Hyun Ryu, Seoul (KR); Dae Un Sung, Incheon (KR); Hyunseok Oh, Gwangju (KR); Donghwi Yoo, Gwangju (KR); Jeongmin Oh, Gwangju (KR)

(21) Appl. No.: 18/522,937

(22) Filed: Nov. 29, 2023

(30) Foreign Application Priority Data
May 23, 2023 (KR) 10-2023-0066499

(51) Int. Cl. G01H 17/00

(52) U.S. Cl. CPC G01H 17/00

(57) ABSTRACT

Noise point data is generated by converting a vibration signal, measured at a source (noise point) of the vibration signal at a first time, into a frequency domain. Sound point data is generated by converting the vibration signal, measured at a sound point (different from the noise point) at the first time, into a frequency domain. Deep learning is applied to the noise point data and the sound point data to generate a noise prediction model for predicting frequency data of a vibration at the noise point using frequency data indicating a vibration at the sound point. The noise prediction model is applied to target vibration signal, measured at the sound point at a second time, to predicting target noise point data indicating vibration at the noise point. The predicted target noise point data is used to diagnose a fault at the noise point.

### CROSS-REFERENCE TO RELATED APPLICATION

This application claims priority to and the benefit of Korean Patent Application No. 10-2023-0066499 filed in the Korean Intellectual Property Office on May 23, 2023, the entire contents of which are incorporated herein by reference.

### TECHNICAL FIELD

The present disclosure relates to a noise point fault diagnosis method and a fault diagnosis system.

### BACKGROUND

In recent years, a vehicle driver's driving sensibility is considered important and noise and vibration experienced by the driver play an important role in view of the vehicle's marketability. Various noises are generated from the vehicle.

Particularly, when a vehicle driving unit and/or part is degraded, noises or vibrations may be caused by the degradation so that it is necessary to determine and deal with the degradation (e.g., replace, update and/or service the degrading vehicle driving unit/part and/or source of noise/vibrations). As described above, vibration generated from a location in which the noise is generated, that is, a noise point may be transmitted to a driver's seat which is a sound point where the driver can hear the noise through several components. In the vibration of the noise point, a signal characteristic may vary during the process of transmitting the vibration to the sound point through several components.

### SUMMARY

The following summary presents a simplified summary of certain features. The summary is not an extensive overview and is not intended to identify key or critical elements.

Systems, apparatuses, and methods are described for degradation level prediction. A method may comprise generating, by a computing device, noise point data by converting a first vibration signal, measured at a noise point at a first time, into a frequency domain, wherein the first vibration signal is generated at the noise point; generating sound point data by converting a second vibration signal measured at a sound point at the first time into a frequency domain, wherein the second vibration signal is based on propagation of the first vibration signal from the noise point to the sound point; generating, by applying deep learning to the noise point data and the sound point data, a noise prediction model configured to generate, using frequency data indicating a vibration at the sound point, frequency data indicating a vibration at the noise point; acquiring a target vibration signal measured at the sound point at a second time; predicting, based on the noise prediction model and the target vibration signal, target noise point data indicating vibration at the noise point at the second time; and diagnosing, based on the predicted target noise point data, a fault at the noise point.

Also, or alternatively, a fault diagnosis system may comprise an input unit configured to acquire: a first vibration signal measured at a noise point at a first time, wherein the first vibration signal is generated at the noise point, a second vibration signal measured at a sound point at the first time, wherein the second vibration signal is based on propagation of the first vibration signal from the noise point to the sound point, and a target vibration signal measured at the sound point at a second time; a prediction model training unit configured to, via deep learning, generate and train a noise prediction model configured to generate, based on frequency data indicating a vibration at the sound point, frequency data indicating a vibration at the noise point; and a controller configured to: provide noise point data and sound point data to the prediction model training unit, wherein the noise point data is generated by converting the first vibration signal into a frequency domain and the sound point data is generated by converting the second vibration signal into the frequency domain; receive the trained noise prediction model; predict, based on the trained noise prediction model and on target sound point data generated by converting the target vibration signal into a frequency domain, target noise point data indicating a vibration at the noise point at the second time; and diagnose, based on the target noise point data, a fault at the noise point.

These and other features and advantages are described in greater detail below.

### BRIEF DESCRIPTION OF THE DRAWINGS

FIG. 1 is a block diagram schematically illustrating a fault diagnosis system according to an example.

FIG. 2 is an exemplary view of a noise prediction model equipped in a fault diagnosis system according to an example.

FIGS. 3A to 3E are graphs illustrating an experiment result for explaining a performance of a noise prediction model according to an example.

FIG. 4 is an exemplary view of a fault diagnosis model equipped in a fault diagnosis system according to an example.

FIG. 5 is a confusion matrix for explaining an accuracy of a fault diagnosis model according to an example.

FIG. 6 is a flowchart of a fault diagnosis method according to an example.

### DETAILED DESCRIPTION

In the following detailed description, only certain examples of the present disclosure have been shown and described, simply by way of illustration, like reference numerals designate like elements throughout the specification, and a redundant description will be omitted. Further, such as a “module” and/or a “unit”, suffixes for components used in the following description are given or mixed and used by considering easiness in preparing a specification and do not have a meaning or role distinguished from each other in themselves. In describing the example disclosed in the present specification, if it is determined that a detailed description of a related publicly known technology may obscure the gist of the example disclosed in the present specification, the detailed description thereof will be omitted. Further, the accompanying drawings are provided for helping to easily understand examples disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

In a configuration which controls another configuration under a specific control condition, among configurations according to an example, a program implemented as a set of instructions which embodies a control algorithm required to control another configuration may be installed. The control configuration processes input data and stored data according to the installed program to generate output data. The control configuration may comprise a nonvolatile memory which may store a program and a memory which may store data.

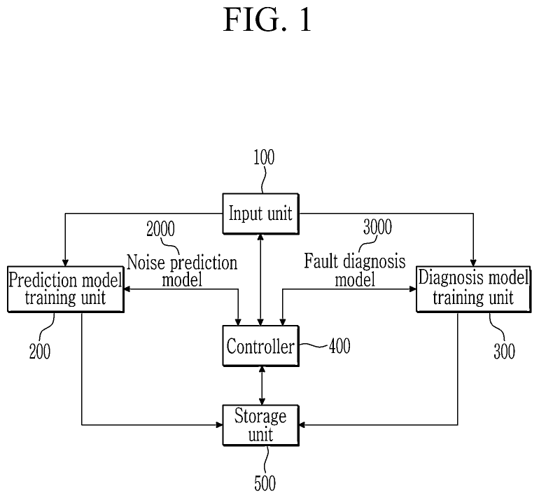

FIG. 1 is a block diagram schematically illustrating a fault diagnosis system according to an example.

A fault diagnosis system 10 according to an example is a computer system which implements various examples described in the present specification. Specifically, the fault diagnosis system 10 may comprise at least one processor and memory, the memory may comprise a non-transitory computer readable storage medium storing instructions that, when executed, cause execution of one or more methods and/or method steps disclosed herein. At least one processor may be configured to executes the instruction stored in the memory to implement various examples described in the present specification.

A “processor” refers to an apparatus configured to processes a calculation operation, a logic operation, and/or a determination operation to provide at least one function. The processors discussed herein may be implemented by hardware, software or a combination of hardware and software. For example, the processor may be implemented by software, such as a task, a class, a sub routine, a process, an object, an execution thread, or a program which is performed in a predetermined region on the memory or hardware such as field-programmable gate array (FPGA) or application-specific integrated circuit (ASIC), and also formed by a combination of the software and hardware. A processor may be part of a computer and/or a part of the processor may be distributed over a plurality of computers.

For example, the fault diagnosis system 10 may be implemented by a super computer, a server, a main frame, a workstation, a personal computer, a laptop computer, a tablet computer, a built-in computer, a wearable computer. The fault diagnosis system 10 may comprise an output device and/or component configured to output one or more results (e.g., an indication and/or notification of degradation level and/or lifetime of a vehicle component), as discussed herein. However, the scope of the present disclosure is not limited thereto and the fault diagnosis system 10 may be an arbitrary computing device which implements various examples described in the present specification.

In some examples, the fault diagnosis system 10 may be implemented by a signal computer device or may also be implemented by a plurality of computer devices.

When the vehicle is driven, noises and/or vibrations may be generated from a plurality of parts. In the vehicle, at least one noise generation location (hereinafter, “noise point”) may indicate various locations in which the noise may be generated in the vehicle, such as a driving system component of the vehicle. For example, the noise point may be a motor decelerator, a brake, and/or a tire of the vehicle. A user riding in the vehicle may sense a noise generated from the noise point. A location at which the user senses a noise generated from the noise point is referred to herein as a “sound point”. For example, a sound point may be a vehicle driver seat.

Hereinafter, for the convenience of description, a point located within a predetermined range with respect to a position of a component (for example, a vehicle motor decelerator) that may generate a noise may be referred to as the noise point.

In the vehicle, at least one subpoint, at which the driving system component corresponding to the noise point is connected to a vehicle, may be included between the noise point and the sound point. The subpoint may indicate an intermediate point in the vehicle between the noise point and the sound point (e.g., through which a vibration from the noise point travels to the sound point). For example, if the noise point is a motor decelerator, the motor decelerator may be connected to the vehicle through a point of each of a motor decelerator mount, a sub frame mount, and a shock absorber top mount. At this time, a point of each of the motor decelerator mount, the sub frame mount, and the shock absorber top mount may be subpoints between the noise point and the sound point. Hereinafter, for the convenience of description, it will be described that the number of at least one subpoints is three (i.e., 3 subpoints will be considered).

In the specification, even though it is described that the fault diagnosis system 10 diagnoses the fault of the vehicle, the present disclosure is not limited thereto. Other devices comprising motorized components configured to generate vibrations when operated may also be configured with a fault diagnosis system as disclosed herein.

If a noise is generated from the noise point, the noise may be sensed by at least one sensor in at least one of various positions. The vibration of the noise may be transmitted to at least one subpoint and the sound point via various components and/or media. The vibration (e.g., noise signal and/or vibration signal) may have one or more signal characteristics that may change during the process of transmitting (e.g., propagating) to the at least one subpoint and/or sound point. The vibration having a changed signal characteristic may be measured by a sensor which is located in, and/or so as to detect vibration at, the at least one subpoint and/or the sound point.

The fault diagnosis system 10 may estimate a transfer function between data indicating a vibration at the noise point and data indicating a vibration in the sound point. The estimation may be based on the deep learning and may predict a vibration signal in the noise point from the vibration signal collected in the sound point based on the transfer function. The deep learning may be implemented by one or more of various models, such as a convolutional neural network (CNN) model or a multi-layered perceptron (MLP) model. The convolutional neural network model may extract and/or simplify (contracts) a feature map from the data and/or convert a dimension of the simplified feature map, which may be simplified (contracted) by means of a flatten layer into one-dimensional vector to perform the learning process.

The fault diagnosis system 10 may diagnose whether the noise point (for example, a motor decelerator) is in a normal state or a faulty state based on a vibration signal in the corresponding noise point. For example, the normal state or the faulty state may be based on (e.g., indicated by) a deep neural network classifier.

For example, the fault diagnosis system 10 may predict data indicating a vibration of a noise generated from the motor decelerator of the vehicle based on data indicating a vibration of a noise sensed from the driver seat and diagnoses whether the motor decelerator of the vehicle is a normal state based on the predicted data.

Referring to FIG. 1, the fault diagnosis system 10 may comprise an input unit 100, a prediction model training unit 200, a diagnosis model training unit 300, a controller 400, and a storage unit 500. The input unit 100, the prediction model training unit 200, the diagnosis model training unit 300, the controller 400 and/or the storage unit 500 may be implemented as one or more processors and memory storing instructions that, when executed by the one or more processors, cause the fault diagnosis system 10 to perform one or more operations described herein.

Sensors may be mounted at (e.g., in, on, so as to detect vibration at) the noise point, at least one subpoint, and/or the sound point (e.g., of the vehicle). The sensors may be configured to measure a vibration signal. For example, acceleration sensors may generate up to three axial data indicating vibration signals in one or more of an x axis, a y axis, and a z axis.

The input unit 100 may acquire the vibration signals measured in the noise point, at least one subpoint, and the sound point from the sensors. The vibration signals measured in the noise point, at least one subpoint, and the sound point may be time-serial data.

Specifically, the input unit 100 may acquire a vibration signal (e.g., a first vibration signal) from one or more first sensors located in a predetermined range from the noise point, may acquire a vibration signal (e.g., a second vibration signal) from one or more second sensors located in a predetermined range from the sound point, and/or may acquire a vibration signal (e.g., a third vibration signal) from a third sensors located in a predetermined range from at least one subpoint.

Further, the input unit 100 may receive data indicating fault information of the noise point corresponding to a time at which sensors measure the vibration signal from the external device. For example, the input unit 100 may acquire data indicating fault information of the motor decelerator of the vehicle at a time at which the first vibration signal is measured, from the external device.

However, the example is not limited thereto. The storage unit 500 may store vibration signals collected from the noise point, at least one subpoint, and the sound point and data indicating the fault information of the noise point at the time at which each vibration signal was measured. For example, the storage unit 500 may store a vibration signal indicating a noise from the vehicle motor decelerator which is a noise point for a vehicle type A, a vibration signal indicating a noise collected from each of a motor decelerator mount, a sub frame mount, and a shock absorber top mount which are at least one subpoint, and a vibration signal indicating a noise collected from the driver seat which is a sound point and data indicating fault information of the vehicle motor decelerator at a time at which each vibration signal is measured.

Hereinafter, for the convenience of description, the controller 400 is discussed as acquiring the vibration signal and data indicating fault information from the input unit 100.

The controller 400 may receive vibration signals from the noise point, at least one subpoint, and/or the sound point, from the input unit 100.

The controller 400 may convert each vibration signal collected from the noise point, at least one subpoint, and/or the sound point into a frequency domain. The controller 400 may convert the vibration signal into data of the frequency domain by means of the fast Fourier transform (FFT).

Hereinafter, for the convenience of description, data which is generated by the controller 400 by converting the vibration signal in the noise point into the frequency domain is referred to as noise point data, data generated by converting the vibration signal in the sound point into the frequency domain is referred to as sound point data, and data generated by converting the vibration signal in the subpoint into the frequency domain is referred to as subpoint data. Hereinafter, the noise point data, sound point data, and subpoint data may correspond to data indicating the fault information of the noise point at the time of measurement. For example, data indicating fault information of the vehicle motor decelerator at a first time may correspond to noise point data, sound point data, and subpoint data indicating the vibration at the first time.

The controller 400 may transmit/send the noise point data, the sound point data, and/or the subpoint data to the prediction model training unit 200. Here, the noise point data, the sound point data, and/or the subpoint data which are transmitted to the prediction model training unit 200 by the controller 400 may match at every measurement time. For example, first noise point data measured at the first time may match first sound point data measured at the first time. Also or alternatively, second noise point data measured at a second time may match second sound point data measured at the second time and second subpoint data measured at the second time.

The prediction model training unit 200 may generate and/or may train a noise prediction model 2000 by means of the deep learning based on noise point data, sound point data, and/or subpoint data that have the same measurement time.

The noise prediction model 2000 may be a transfer function indicating a relationship which outputs frequency data indicating a vibration of the noise point with frequency data indicating the vibration of the sound point as an input. Also, or alternatively, the noise prediction model 2000 may include a first model and a second model. The first model may comprise a first transfer function indicating a relationship between frequency data indicating a vibration of the subpoint with frequency data indicating the vibration of the sound point (i.e., the first transfer function outputs the frequency data indicating the vibration at the subpoint from the frequency data indicating the vibration at the sound point as an input). The second model may comprise a second transfer function indicating a relationship between frequency data indicating a vibration at the noise point and frequency data indicating the vibration of the subpoint (i.e., the second transfer function outputs the frequency data indicating the vibration at the noise point based on the frequency data indicating the vibration at the subpoint as input). In this case, the prediction model training unit 200 may generate and/or may train the first model and/or the second model by means of the deep learning based on the noise point data, the sound point data, and/or the subpoint data which have the same measurement time.

The prediction model training unit 200 may estimate the transfer function based on the noise point data, the sound point data, and the subpoint data by means of operational transfer path analysis (OTPA) and/or the convolutional neural network (CNN).

The prediction model training unit 200 may determine the characteristic of the noise prediction model 2000 indicating a characteristic of the signal which changes from the sound point to the noise point by utilizing noise point data, sound point data, and/or subpoint data which change over time (hereinafter, “driving data) by means of the OTPA.

The prediction model training unit 200 may train the noise prediction model 2000 based on the CNN and may train the noise prediction model 2000 to receive data indicating the vibration of the sound point to output data indicating the vibration of the noise point at the time of measuring the sound point.

The prediction model training unit 200 may provide the trained noise prediction model 2000 to the controller 400.

The controller 400 controls operations of the input unit 100, the prediction model training unit 200, the diagnosis model training unit 300, and the storage unit 500. The controller 400 may be implemented as hardware, software, or a combination of hardware and software. The controller 400 may be implemented as a microprocessor.

The controller 400 may control the overall training process of the prediction model training unit 200. The controller 400 may control a process of detecting data indicating the vibration of the noise point at a time at which the sound point is measured, from data indicating the vibration of the sound point, using the trained noise prediction model 2000. The controller 400 may use the trained noise prediction model 2000 to predict data indicating the vibration of the noise point at the time at which the vibration is measured in the sound point, from data indicating a vibration which is measured from the sound point at an arbitrary time.

The controller 400 may determine the effectiveness of the trained noise prediction model 2000

At an arbitrary time, data A indicating a vibration measured from the sound point may match data B1 indicating a vibration measured from the noise point at the same time. In this case, the controller 400 may predict data B2 indicating the vibration for the noise point by inputting the data A to the noise prediction model 2000 and compares the predicted data B2 with data B1 to determine the effectiveness of the noise prediction model 2000.

The controller 400 may determine the effectiveness of the noise prediction model 2000 based on a result obtained by comparing absolute values of peaks of the data B1 and the data B2 and root mean squares (RMS). For example, If absolute values of peaks of the data B2 are within a predetermined range from absolute values of peaks of the data B1, the controller 400 may determine that the noise prediction model 2000 is effective.

The controller 400 may determine whether the noise point is a normal state based on the noise point data predicted by the trained noise prediction model 2000. By determining whether the noise point is a normal state, the controller 400 may utilize a fault diagnosis model 3000 generated by the diagnosis model training unit 300.

The storage unit 500 may store a training dataset and a test dataset for the fault diagnosis model 3000. Some of data in which data (hereinafter, “noise point frequency data” obtained by converting data (hereinafter, “noise point vibration signal”) indicating the vibration signal collected from sensors within a predetermined range from the noise point into the frequency domain is labeled with fault information of the noise point at the time at which the noise point vibration signal is measured is training dataset and the other may be test dataset. Here, the fault information may comprise a type of fault (degradation) of the vehicle or whether it is faulty.

For example, the training dataset include data in which frequency data indicating a noise in the vehicle motor decelerator belonging to a vehicle type A is labeled with fault information indicating that a type B fault occurs in vehicle motor decelerator at the vibration signal measurement time. The training dataset may be utilized by the diagnosis model training unit 300 to train the fault diagnosis model 3000.

Further, the training dataset may include not only data which is labeled with the noise point vibration signal stored in the storage unit 500 and the fault information of the corresponding noise point, but also data which is labeled with noise point data predicted by the noise prediction model 2000 and the fault information of the corresponding noise point.

However, the example is not limited thereto, the storage unit 500 may store the noise point vibration signal and labeling information indicating fault information of the corresponding noise point. In this case, the controller 400 may convert the vibration signal stored in the storage unit 500 into a frequency domain and labels the converted frequency data with data indicating the fault information of the noise point to generate training dataset.

Hereinafter, for the convenience of description, the controller 400 may acquire the training dataset and the test dataset from the storage unit 500.

The controller 400 may provide the training dataset and the test dataset to the diagnosis model training unit 300. The diagnosis model training unit 300 may train the fault diagnosis model 3000 by utilizing the training dataset and tests the fault diagnosis model 3000 by utilizing the test dataset. The fault diagnosis model 3000 is implemented by means of the Regression model for predicting a lifetime of the noise point. The fault diagnosis model 3000 learns a method of predicting fault information of the noise point from data indicating a vibration of the noise point using the training dataset by means of the deep learning.

Hereinafter, for the convenience of description, the trained and tested fault diagnosis model 3000 is referred to as a trained fault diagnosis model 3000.

The diagnosis model training unit 300 may provide the trained fault diagnosis model 3000 to the controller 400.

The controller 400 controls the entire training and test process of the diagnosis model training unit 300. The controller 400 may perform the control in the process of predicting the fault information of the noise point from data indicating the vibration of the noise point using the trained fault diagnosis model 3000. The controller 400 diagnoses whether the noise point is faulty at a time at which the vibration is measured from the sound point, from data indicating the vibration of the noise point predicted by the noise prediction model 2000 by means of the trained fault diagnosis model 3000.

The storage unit 500 may store labeling information indicating vibration data in the noise point, the sound point and the subpoint acquired by the input unit 100 and fault information of the noise point corresponding to the time of measuring the vibration data. The storage unit 500 may store the noise prediction model 2000 trained by the prediction model training unit 200 and the fault diagnosis model 3000 trained by the diagnosis model training unit 300. The storage unit 500 may store noise point data predicted by the noise prediction model 2000 and data indicating fault information predicted by the fault diagnosis model 3000.

The storage unit 500 may include at least one type of storage medium among memories of a flash memory type, a hard disk type, a micro type, and a card type memory (for example, a SD card (Secure Digital Card) or an XD card (eXtream Digital Card)) and memories of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type memories.

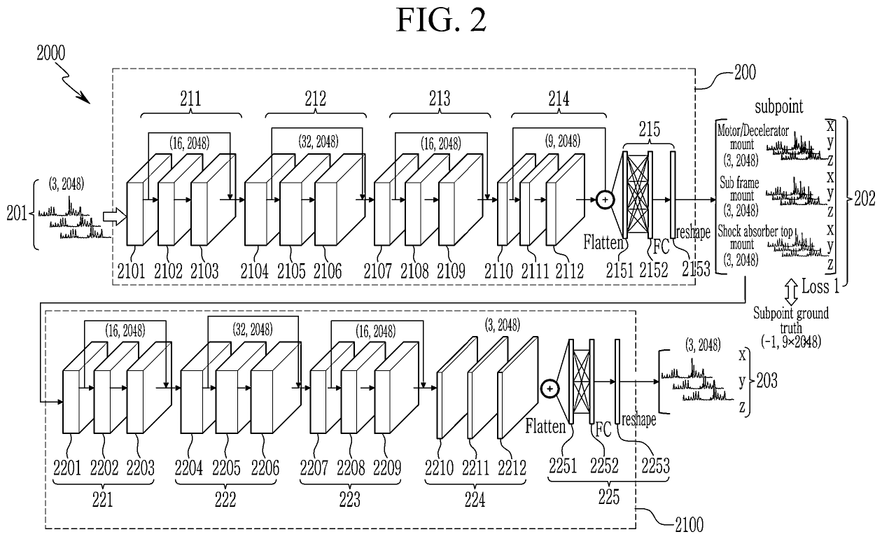

FIG. 2 is an exemplary view of a noise prediction model equipped in a fault diagnosis system according to an example.

Referring to FIG. 2, the noise prediction model 2000 may comprise a plurality of calculation blocks 211 to 214 and 221 to 224 and at least one of flatten block 215 and 225.

The plurality of calculation blocks 211 to 214 and 221 to 224 indicates a transfer function from sound point data to noise point data. The plurality of calculation blocks 211 to 214 and 221 to 224 may comprise a plurality of convolutional layers 2101 to 2112 and 2201 to 2222. Each of the plurality of convolutional layers 2101 to 2112 and 2201 to 2222 may be 1D-convolutional layer which may perform one-dimensional convolution operation. The plurality of convolutional layers 2101 to 2112 and 2201 to 2222 extracts a feature for generating a transfer function from the sound point data to the noise point data by means of the one-dimensional convolution operation. Each of the plurality of calculation blocks 211 to 214 and 221 to 224 extracts a feature from input data to generate a feature map.

At least one of fully connected block 215 and 225 (for example, 215) may flatten data generated by the plurality of corresponding first calculation block 211 to 214, among the plurality of calculation blocks 211 to 214 and 221 to 224.

According to an example, the noise prediction model 2000 may generate a prediction value corresponding to the noise point data 203 from the sound point data 201 using the sound point data 201 and the noise point data 203. A time of measuring a vibration time corresponding to the sound point data 201 may be the same as a time of measuring a vibration time corresponding to the noise point data 203. The prediction model training unit 200 may determine (e.g., may calculate) a loss function value by digitizing a difference between prediction data which is output by inputting the sound point data 201 into the noise prediction model 2000 and noise point data 203 corresponding to the sound point data 201 using a loss function and may train noise prediction model 2000 to make the loss function value minimum.

Each of the sound point data 201 and the noise point data 203 may comprise two-dimensional matrix including x axis data, y axis data, and z axis data of the corresponding vibration signal. Here, the two-dimensional matrix may have a (3, n) size including n data (n is 1 or larger natural number) for each of three axes (x axis, y axis, and z axis). For example, each of the sound point data 201 and the noise point data 203 may be a two-dimensional (3, 2048) size matrix.

Further, according to the example, the plurality of calculation blocks 211 to 214 and 221 to 224 and at least one of fully connected blocks 215 and 225 may generate a prediction value corresponding to the noise point data 203 from the sound point data 201 using sound point data 201, the subpoint data 202, and the noise point data 203. The measurement time of the vibration time corresponding to the subpoint data 202 may be the same time as the measurement time of the vibration time corresponding to the sound point data 201 and the noise point data 203. The subpoint data 202 may comprise a two-dimensional matrix including x axis data, y axis data, and z axis data of the vibration signal in at least one subpoint. Here, the two-dimensional matrix may have a (3, n) size including n data (n is 1 or larger natural number) for each of three axes (x axis, y axis, and z axis). For example, each of the subpoint data 202 is a two-dimensional matrix for three axes in each of three subpoints so that it may be a total of a two-dimensional (9, 2048) size matrix.

The prediction model training unit 200 may train a method of generating the noise point data 203 corresponding to the sound point data 201 from the sound point data 201 by means of the plurality of calculation blocks 211 to 214 and 221 to 224. A kernel which is applied to the plurality of calculation blocks 211 to 214 and 221 to 224 extracts and optimizes the feature from the input data while updating a weight value by means of the deep learning.

Referring to FIG. 2, the noise prediction model 2000 may comprise a first model 2100 and a second model 2200. The first model 2100 may indicate a characteristic of a signal which changes, by means of a first transfer function indicating a relationship from the sound point data 201 to the subpoint data 202. The second model 2200 may indicate a characteristic of a signal which changes, by means of a second transfer function indicating a relationship from the subpoint data 202 to the noise point data 203.

The first model 2100 may comprise a plurality of first calculation blocks 211 to 214 and a fully connected block 215 among the plurality of calculation blocks 211 to 214 and 221 to 224 and the second model 2200 may comprise a plurality of second calculation blocks 221 to 224 and a fully connected block 225 among the plurality of calculation blocks 211 to 214 and 221 to 224.

The plurality of first calculation blocks 211 to 214 may comprise a plurality of first convolutional layers 2101 to 2112 and the plurality of second calculation blocks 221 to 224 may comprise a plurality of second convolutional layers 2201 to 2212. The fully connected block 215 may flatten an output of the plurality of first calculation blocks 211 to 214 and the fully connected block 225 may flatten the plurality of second calculation blocks 221 to 224.

One size of kernel may be commonly applied to the plurality of convolutional layers (for example, 2101 to 2103) included in each of the plurality of calculation blocks 211 to 214 and 221 to 224 (for example, 211). The prediction model training unit 200 may determine a weight value and/or a bias of the kernel (e.g., applied to each of the plurality of calculation blocks 211 to 214 and 221 to 224) by means of the deep learning.

The plurality of convolutional layers (for example, 2101 to 2103) included in the plurality of calculation blocks 211 to 214 and 221 to 224 (for example, 211) may be implemented by a skip connection structure conceived from a structure of a residual network (ResNet).

FIG. 2 illustrates that each of the plurality of calculation blocks 211 to 214 and 221 to 224 comprises three convolutional layers, but this example is just for the convenience of description. the present disclosure is not limited thereto. Each of the plurality of calculation blocks 211 to 214 and 221 to 224 may include two or more convolutional layers. Hereinafter, for the convenience of description, it is described that the number of plurality of convolutional layers included by each of the plurality of calculation blocks is three.

The prediction model training unit 200 may train a method of generating subpoint data 202 corresponding to the sound point data 201 from the sound point data 201 by means of the plurality of first calculation blocks 211 to 214. The prediction model training unit 200 may compare prediction data output from the fully connected block 215 and subpoint data 202 received from the input unit 100. The prediction model training unit 200 may determine (e.g., may calculate) a first loss function value Loss 1 by digitizing a difference between the prediction data output from the fully connected block 215 and the subpoint data 202 using the loss function and may train the plurality of first calculation blocks 211 to 214 to make the first loss function value Loss1 minimum.

The prediction model training unit 200 may train a method of generating noise point data 203 corresponding to the subpoint data 202 from the subpoint data 202 by means of the plurality of second calculation blocks 221 to 224. The prediction model training unit 200 may compare prediction data output from the fully connected block 225 and noise point data 203 received from the input unit 100. The prediction model training unit 200 may determine (e.g., may calculate) a second loss function value Loss 2 by digitizing a difference between the prediction data output from the fully connected block 225 and the noise point data 203 using the loss function and may train the plurality of second calculation blocks 221 to 224 to make the second loss function value Loss2 minimum.

Hereinafter, operations of layers included in the plurality of calculation blocks 211 to 214, 221 to 224 and at least one of the fully connected block 215 and 225 will be described.

The calculation block 211 may comprise a plurality of convolutional layers 2101 to 2103. A size of a kernel which is applied to each of the plurality of convolutional layers 2101 to 2103 may be the largest among the plurality of first calculation blocks 211 to 214. For example, 128 size kernel may be applied to each of the plurality of convolutional layers 2101 to 2103. The calculation block 211 may generate output data which increases a number of rows from the input data, with the sound point data 201 as the input data. For example, the calculation block 211 may generate a two-dimensional (16, 2048) size matrix as output data with sound point data 201 which is the two-dimensional (3, 2048) size matrix as an input.

An output of the first convolutional layer 2101 among the plurality of convolutional layers 2101 to 2103 is input to the second convolutional layer 2102 and is added to an output of the third convolutional layer 2103. The output of the second convolutional layer 2102 may be an input of the third convolutional layer 2103. The output of the third convolutional layer 2103 and the output of the first convolutional layer 2101 are added in an element-wise manner to be transmitted to the calculation block 212.

The calculation block 212 may comprise a plurality of convolutional layers 2104 to 2106. A size of the kernel which is applied to each of the plurality of convolutional layer 2104 to 2106 may be smaller than a size of the kernel which is applied to the calculation block 211. For example, a 64 size of kernel may be applied to each of the plurality of convolutional layers 2104 to 2106. The calculation block 212 may generate output data which increases a number of rows from input data with the output of the calculation block 211 as input data. For example, the calculation block 212 may generate a two-dimensional (32, 2048) size matrix as output data with two-dimensional (16, 2048) size matrix as an input.

An output of the first convolutional layer 2104 of the plurality of convolutional layers 2104 to 2106 is input to the second convolutional layer 2105 and is also added to the output of the third convolutional layer 2106. An output of the second convolutional layer 2105 may be input to the third convolutional layer 2106. The output of the third convolutional layer 2106 and the output of the first convolutional layer 2104 are added in an element-wise manner to be transmitted to the calculation block 213.

The calculation block 213 may comprise a plurality of convolutional layers 2107 to 2109. A kernel size applied to each of the plurality of convolutional layers 2107 to 2109 may be smaller than a kernel size applied to the calculation block 212. For example, a 32 size kernel may be applied to each of the plurality of convolutional layers 2107 to 2109. The calculation block 213 may generate output data which reduces a number of rows from the input data, with an output of the calculation block 212 as input data. For example, the calculation block 213 may generate a two-dimensional (16, 2048) size matrix as output data with the two-dimensional (32, 2048) size matrix as an input.

An output of the first convolutional layer 2107 among the plurality of convolutional layers 2107 to 2109 is input to the second convolutional layer 2108 and is added to an output of the third convolutional layer 2109. The output of the second convolutional layer 2108 may be an input of the third convolutional layer 2109. The output of the third convolutional layer 2109 and the output of the first convolutional layer 2107 are added in an element-wise manner to be transmitted to the calculation block 214.

The calculation block 214 may comprise a plurality of convolutional layers 2110 to 2112. A size of the kernel which is applied to each of the plurality of convolutional layers 2110 to 2112 may be smaller than a size of the kernel which is applied to the calculation block 213. For example, a 16 size kernel may be applied to each of the plurality of convolutional layers 2110 to 2112. The calculation block 214 may generate output data which reduces a number of rows from input data with the output of the calculation block 213 as input data. For example, the calculation block 214 may generate a two-dimensional (9, 2048) size matrix as output data with two-dimensional (16, 2048) size matrix as an input.

An output of the first convolutional layer 2110 of the plurality of convolutional layers 2110 to 2112 is input to the second convolutional layer 2111 and is also added to the output of the third convolutional layer 2112. An output of the second convolutional layer 2111 may be input to the third convolutional layer 2112. The output of the third convolutional layer 2112 and the output of the first convolutional layer 2110 are added in an element-wise manner to be transmitted to the fully connected block 215.

The fully connected block 215 may comprise a flattening layer 2151, a fully connected layer 2152, and a reshape layer 2153.

The flattening layer 2151 may generate a one-dimensional vector with the output of the calculation block 214 as input data. For example, the flattening layer 2151 may generate a one-dimensional vector with a length of (9*2048) with the two-dimensional (9, 2048) size matrix as an input. The flattening layer 2151 may generate output data which may flatten the two-dimensional matrix to a one-dimensional vector by changing a dimension while maintaining the same size of the input data.

The fully connected layer 2152 is fully connected to the flattening layer 2151 to output prediction data corresponding to each of at least one subpoint. The fully connected layer 2152 may perform an operation which passes through the fully connected layer with the output of the flattening layer 2151 as input data to output a one-dimensional vector. For example, the fully connected layer 2152 may perform an operation of Wx+b with one-dimensional vector with a length of (9*2048) as an input to generate a one-dimensional vector with a length of (9*2048). Here, x indicates an input, W indicates a weight value, and b indicates a bias.

The reshape layer 2153 outputs a multi-dimensional vector of multi-channel by means of a reshape process with an output of the fully connected layer 2152 as input data. For example, the reshape layer 2153 outputs a two-dimensional (9, 2048) size matrix corresponding to three axes (x axis, y axis, and z axis) for each of three subpoints with one dimensional vector with a length of (9*2048) as an input.

The reshape layer 2153 may generate output data obtained by reshaping a one-dimensional vector into a two-dimensional matrix by changing a dimension while maintaining the same size of the input data.

The fully connected block 215 may generate prediction data corresponding to three subpoints from the input data with the output of the calculation block 214 as input data. Here, a number of rows in the matrix indicating prediction data generated by the reshape layer 2153 may be equal to a number of rows in the matrix indicating the output of the calculation block 214. For example, a two dimensional (9, 2048) size matrix corresponding to three axes (x axis, y axis, and z axis) for each of three subpoints is input to nine input nodes of the fully connected block 215 and a two-dimensional (9, 2048) size matrix may be output from the nine output nodes of the fully connected block 215. Here, the two-dimensional (9, 2048) size matrix generated by the fully connected block 215 may be data corresponding to three axes (x axis, y axis, an z axis) for each of three subpoints and include a vector with a length of 2048 corresponding to each of three axes of three channels. In other words, the two-dimensional (9, 2048) size matrix generated by the fully connected block 215 may be divided into a two-dimensional (3, 2048) size matrix corresponding three axes (x axis, y axis, and z axis) for a first subpoint, a two-dimensional (3, 2048) size matrix corresponding to three axes (x axis, y axis, and z axis) for a second subpoint, and a two-dimensional (3, 2048) size matrix corresponding to three axes (x axis, y axis, and z axis) for a third subpoint.

As described above, the number of channels of each of the plurality of first convolutional layers 2101 to 2112 may be determined in advance to generate corresponding prediction data in consideration of a number of axes of the acceleration sensor which collects the sound point data 201 and the subpoint data 202 and the number of at least one subpoint. Further, the prediction model training unit 200 may determine a weight value and a bias of the kernel which is applied to each of the plurality of first calculation blocks 211 to 214 by means of learning.

The calculation block 221 may comprise a plurality of convolutional layers 2201 to 2203. A size of a kernel which is applied to each of the plurality of convolutional layers 2201 to 2203 may be the largest among the plurality of second calculation blocks 221 to 224. For example, 128 size kernel may be applied to each of the plurality of convolutional layers 2201 to 2203. The calculation block 221 may generate output data which increases a number of rows from the input data, with the subpoint data 202 as the input data. For example, the calculation block 221 may generate a two-dimensional (16, 2048) size matrix as output data with subpoint data 202 which is the two-dimensional (3, 2048) size matrix as an input.

An output of the first convolutional layer 2201 among the plurality of convolutional layers 2201 to 2203 is input to the second convolutional layer 2202 and is added to an output of the third convolutional layer 2203. The output of the second convolutional layer 2202 may be an input of the third convolutional layer 2203. The output of the third convolutional layer 2203 and the output of the first convolutional layer 2201 are added in an element-wise manner to be transmitted to the calculation block 222.

The calculation block 222 may comprise a plurality of convolutional layers 2204 to 2206. A size of the kernel which is applied to each of the plurality of convolutional layer 2204 to 2206 may be smaller than a size of the kernel which is applied to the calculation block 221. For example, a 64 size of kernel may be applied to each of the plurality of convolutional layers 2204 to 2206. The calculation block 222 may generate output data which increases a number of rows from input data with the output of the calculation block 221 as input data. For example, the calculation block 222 may generate a two-dimensional (32, 2048) size matrix as output data with two-dimensional (16, 2048) size matrix as an input.

An output of the first convolutional layer 2204 of the plurality of convolutional layers 2204 to 2206 is input to the second convolutional layer 2205 and is also added to the output of the third convolutional layer 2206. An output of the second convolutional layer 2205 may be input to the third convolutional layer 2206. The output of the third convolutional layer 2206 and the output of the first convolutional layer 2204 are added in an element-wise manner to be transmitted to the calculation block 223.

The calculation block 223 may comprise a plurality of convolutional layers 2207 to 2209. A kernel size applied to each of the plurality of convolutional layers 2207 to 2209 may be smaller than a kernel size applied to the calculation block 222. For example, a 32 size kernel may be applied to each of the plurality of convolutional layers 2207 to 2209. The calculation block 223 may generate output data which reduces a number of rows from the input data, with an output of the calculation block 222 as input data. For example, the calculation block 223 may generate a two-dimensional (16, 2048) size matrix as output data with the two-dimensional (32, 2048) size matrix as an input.

An output of the first convolutional layer 2207 among the plurality of convolutional layers 2207 to 2209 is input to the second convolutional layer 2208 and is added to an output of the third convolutional layer 2209. The output of the second convolutional layer 2208 may be an input of the third convolutional layer 2209. The output of the third convolutional layer 2209 and the output of the first convolutional layer 2207 are added in an element-wise manner to be transmitted to the calculation block 224.

The calculation block 224 may comprise a plurality of convolutional layers 2210 to 2212. A size of the kernel which is applied to each of the plurality of convolutional layer 2210 to 2212 may be smaller than a size of the kernel which is applied to the calculation block 223. For example, a 16 size of kernel may be applied to each of the plurality of convolutional layers 2210 to 2212. The calculation block 224 may generate output data which reduces a number of rows from input data with the output of the calculation block 223 as input data. For example, the calculation block 224 may generate a two-dimensional (3, 2048) size matrix as output data with two-dimensional (16, 2048) size matrix as an input.

An output of the first convolutional layer 2210 of the plurality of convolutional layers 2210 to 2212 is input to the second convolutional layer 2211 and is also added to the output of the third convolutional layer 2212. An output of the second convolutional layer 2211 may be input to the third convolutional layer 2212. The output of the third convolutional layer 2212 and the output of the first convolutional layer 2210 are added in an element-wise manner to be transmitted to the fully connected block 225.

The fully connected block 225 may comprise a flattening layer 2251, a fully connected layer 2252, and a reshape layer 2253.

The flattening layer 2251 may generate a one-dimensional vector with the output of the calculation block 224 as input data. For example, the flattening layer 2251 may generate a one-dimensional vector with a length of (3*2048) with the two-dimensional (3, 2048) size matrix as an input.

The flattening layer 2251 may generate output data which may flatten the two-dimensional matrix to a one-dimensional vector by changing a dimension while maintaining the same size of the input data.

The fully connected layer 2252 may be fully connected to the flattening layer 2251 to output prediction data corresponding to the sound point. The fully connected layer 2252 may perform an operation which passes through the fully connected layer with the output of the flattening layer 2251 as input data to output a one-dimensional vector. For example, the fully connected layer 2252 may perform an operation of Wx+b with one-dimensional vector with a length of (3*2048) as an input to generate a one-dimensional vector with a length of (3*2048). Here, x indicates an input, W indicates a weight value, and b indicates a bias.

The reshape layer 2253 may output a multi-dimensional vector of multi-channel by means of a reshape process with an output of the fully connected layer 2252 as input data. For example, the reshape layer 2253 may output a two-dimensional (3, 2048) size matrix corresponding to three axes (x axis, y axis, and z axis) for three noise points with one dimensional vector with a length of (3*2048) as an input.

The reshape layer 2253 may generate output data obtained by reshaping one-dimensional vector into two-dimensional matrix by changing a dimension while maintaining the same size of the input data.

The fully connected block 225 may generate prediction data corresponding to the noise point from the input data with the output of the calculation block 224 as input data. Here, a number of rows in the matrix indicating prediction data generated by the reshape layer 2253 may be equal to a number of rows in the matrix indicating the output of the calculation block 224. For example, the fully connected block 215 may generate the two-dimensional (3, 2048) size matrix with a two-dimensional (3, 2048) size matrix as an input.

As described above, the number of channels of each of the plurality of second convolutional layers 2201 to 2212 may be determined in advance to generate corresponding prediction data in consideration of a number of at least one subpoint and the sound point data 201. A number of axes of the acceleration sensor which collects the subpoint data 202. Further, the prediction model training unit 200 may determine a weight value and a bias of the kernel which is applied to each of the plurality of second calculation blocks 221 to 224 by means of learning.

The prediction model training unit 200 may deduce a first loss function value Loss 1 for the first transfer function and deduce a second loss function value Loss2 for the second transfer function. The prediction model training unit 200 may deduce a final loss function Total Loss based on the first loss function value Loss 1 and the second loss function value Loss 2.

The prediction model training unit 200 may train the noise prediction model 2000 based on the final loss function. The prediction model training unit 200 may provide the generated noise prediction model 2000 to the controller 400 by means of the deep learning. The storage unit 500 may store the trained noise prediction model 2000.

As described above, the controller 400 may provide the sound point data 201, the subpoint data 202, and the noise point data 203 to the prediction model training unit 200 and is provided with the noise prediction model 2000 from the prediction model training unit 200.

The controller 400 may input sound point data (hereinafter, “target sound point data”) which is measured from the sound point at an arbitrary time to the trained noise prediction model 2000 and may acquire a vibration signal (hereinafter, “target noise point data” in a noise point at a time at which the vibration signal corresponding to the target sound point data is measured. For example, in the target sound point data, noise point data with the same measurement time may not match. In this case, the controller 400 may input the target sound point data to the trained noise prediction model 2000 to predict the target noise point data at a measurement time of the vibration signal corresponding to the target sound point data.

As described above, even if it is difficult to measure the vibration signal from the noise point, the noise prediction model 2000 may predict the vibration of the noise point using the vibration signal measured in the sound point.

The target noise point data may include a two-dimensional (3, n) size matrix (n is one or larger natural number) corresponding to three axes (x axis, y axis, and z axis) of the corresponding vibration signal. For example, the target noise point data may be a two-dimensional (3, 2048) size matrix.

If the trained noise prediction model 2000 may receive the target sound point data, the noise prediction model may predict the target noise point data. The controller 400 may convert the target noise point data from the frequency domain into a time domain to generate a vibration signal indicated by the target noise point data. For example, data predicted by the noise prediction model 2000 based on the vibration signal acquired from the driver seat by the controller 400 may be a vibration signal which is predicted as a noise of the vehicle motor decelerator at a time at which the vibration signal is acquired in the driver seat.

The storage unit 500 may store the target noise point data.

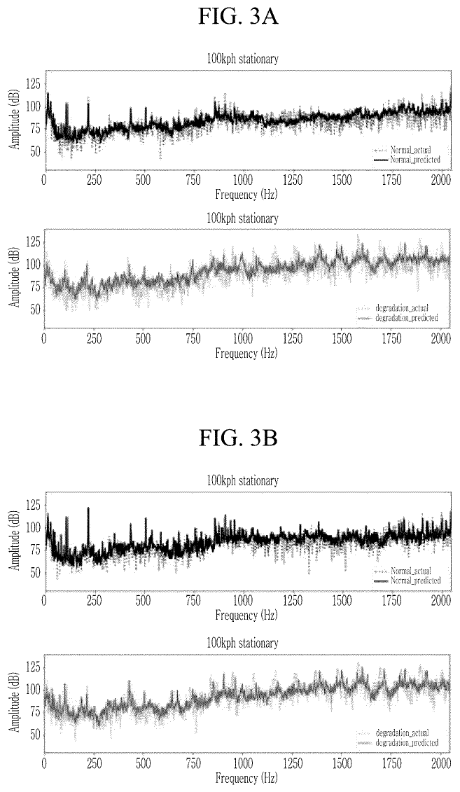

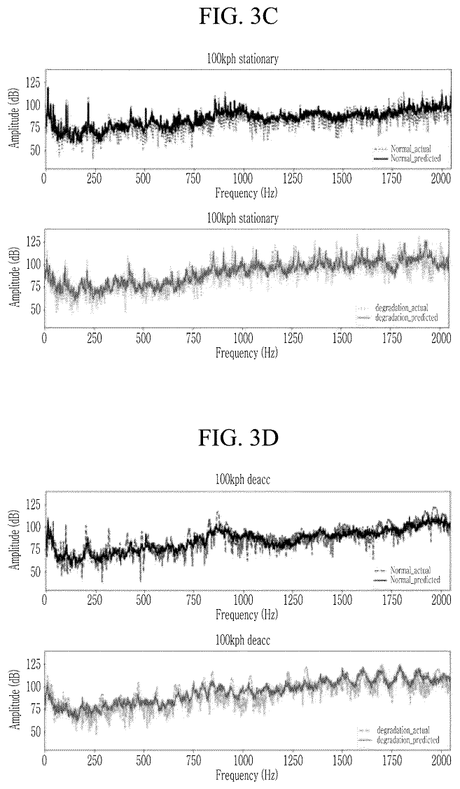

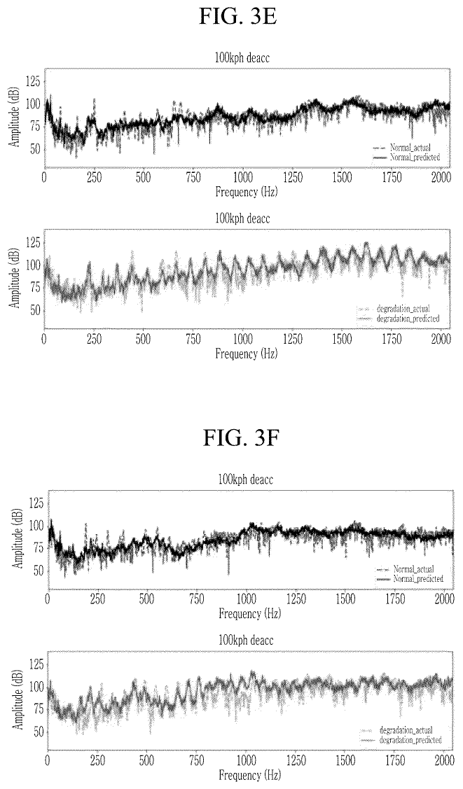

FIGS. 3A to 3E are graphs illustrating an experiment result for explaining a performance of a noise prediction model according to an example.

FIGS. 3A to 3E illustrate frequency data representing a vibration of a decelerator in a predetermined section if the decelerator is a noise point.

‘Normal_true’ may indicate frequency data (hereinafter, “actual normal data” which is actually measured from the position within a predetermined range from the position of the decelerator if the decelerator is in a normal state.

‘degradation_true’ may indicate frequency data (hereinafter, “actual fault data”) which is actually measured from the position in a predetermined range from the position of the decelerator if the decelerator is degraded.

‘Normal_predicted’ may indicate data (hereinafter “prediction normal data”) which is predicted by the noise prediction model 2000 from the sound point data If the decelerator is in a normal state.

‘degradation_predicted’ may indicate data (hereinafter “predicted fault data”) predicted from the sound point data by the noise prediction model 2000 If the decelerator is degraded.

FIGS. 3A to 3C are data of a vehicle including a noise point and a sound point that is steadily driven at 100 km/h (100 kph, constant speed). FIGS. 3D to 3F are data of a vehicle decelerating from 100 km/h (100 kph).

Referring to FIGS. 3A to 3E, based on the predicted normal data being compared with actual normal data and predicted fault data being compared with actual fault data, the noise prediction model 2000 may not exactly predict, but may follow a tendency of the frequency based on the comparisons. Accordingly, the noise prediction model 2000 may deduce the state of the decelerator (example noise point) accurately (e.g., accurately to within an acceptable error level).

As described above, the controller 400 may compare the predicted normal data with actual normal data and/or compare predicted fault data with actual fault data to determine effectiveness of the noise prediction model 2000.

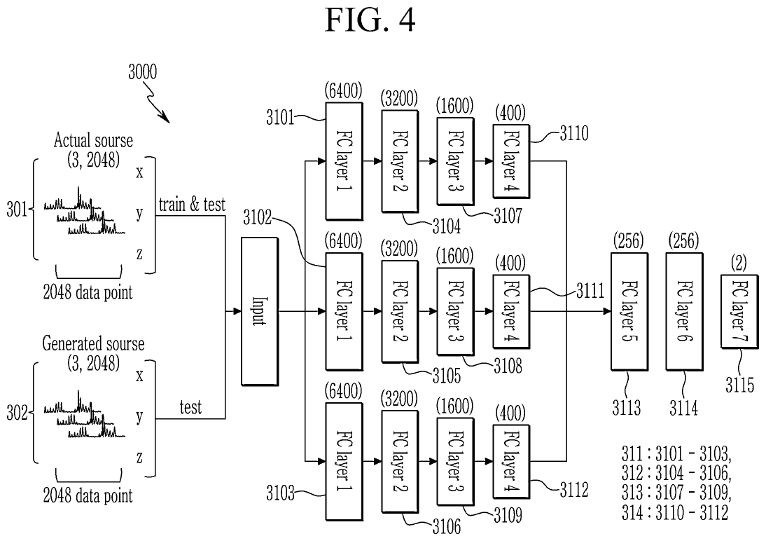

The controller 400 may diagnose fault information indicated by target noise point data generated by the noise prediction model 2000. In order to diagnose the fault information indicated by the target noise point data, the controller 400 may provide the training dataset and the target noise point data acquired from the storage unit 500 to the diagnosis model training unit 300. Hereinafter, an operation of the diagnosis model training unit 300 of diagnosing the fault information of the target noise point data will be described with reference to FIG. 4.

FIG. 4 is an exemplary view of a fault diagnosis model equipped in a fault diagnosis system according to an example.

Referring to FIG. 4, the fault diagnosis model 3000 may comprise a plurality of fully connected layers (FC layer) 311 to 314 and plurality of layers 3113-3115.

The diagnosis model training unit 300 may input training dataset among the actual frequency data 301 to the fault diagnosis model 3000 to train the fault diagnosis model 3000.

The actual frequency data 301 may comprise a plurality of noise point frequency data corresponding to a vibration signal which may be actually measured at the noise point and labeling data indicating fault information of the noise point at the measurement time of the vibration signal and the labeling data may match each corresponding noise point frequency data. Each of the plurality of noise point frequency data may comprise data of two-dimensional (3, n) size matrix (n is a natural number of 1 or larger) corresponding to three axes (x axis, y axis, and z axis). For example, the actual frequency data 301 may be a two-dimensional (3, 2048) size matrix.

A first fully connected layer 311 may comprise a plurality of layers 3101 to 3103. The plurality of layers 3101 to 3103 may have one weight value and bias. Data corresponding to one axis, among actual frequency data 301, may be input to each of the plurality of layers 3101 to 3103.

For example, the description will be made under the assumption that for two dimensional actual frequency data 301 with a size of 3, 2048 is input to the first fully connected layer 311. One dimensional vector with a length of 2048 indicating a first row corresponding to the x axis, among actual frequency data 301, is input to the layer 3101. One dimensional vector with a length of 2048 indicating a second row corresponding to the y axis, among actual frequency data 301, is input to the layer 3102. One dimensional vector with a length of 2048 indicating a third row corresponding to the z axis, among actual frequency data 301, is input to the layer 3103.

Each of the plurality of layers 3101 to 3103 may have a predetermined number of nodes and/or may determine (e.g., may calculate) the input data as matrix to output data corresponding to the number of nodes. For example, each of the plurality of layers 3101 to 3103 may comprise 6400 nodes, a layer 3101 outputs a one-dimensional vector with a length of 6400 for the x axis, a layer 3102 outputs a one-dimensional vector with a length of 6400 for the y axis, and/or a layer 3103 outputs a one-dimensional vector with a length of 6400 for the z axis.

The second fully connected layer 312 may comprise a plurality of layers 3104 to 3106. The plurality of layers 3104 to 3106 may have one weight value and bias. An output of a corresponding layer, among the plurality of layers 3101 to 3103 may be input to the plurality of layers 3104 to 3106. For example, an output of the layer 3101 may be input to the layer 3104. An output of the layer 3102 may be input to the layer 3105. An output of the layer 3103 may be input to the layer 3106.

Each of the plurality of layers 3104 to 3106 may have a predetermined number of nodes and/or may determine (e.g., may calculate) the input data as matrix to output data corresponding to the number of nodes. For example, one or more (e.g., each) of the plurality of layers 3104 to 3106 may comprise 3200 nodes, the layer 3104 outputs a one-dimensional vector with a length of 3200 for the x axis, the layer 3105 may output a one-dimensional vector with a length of 3200 for the y axis, and the layer 3106 may output a one-dimensional vector with a length of 3200 for the z axis.

The third fully connected layer 313 may comprise a plurality of layers 3107 to 3109. The plurality of layers 3107 to 3109 may have one weight value and bias. An output of a corresponding layer, among the plurality of layers 3104 to 3106 is input to the plurality of layers 3107 to 3109. For example, an output of the layer 3104 may be input to the layer 3107. An output of the layer 3105 may be input to the layer 3108. An output of the layer 3106 may be input to the layer 3109.

Each of the plurality of layers 3107 to 3109 may have a predetermined number of nodes and/or may determine (e.g., may calculate) the input data as matrix to output data corresponding to the number of nodes. For example, each of the plurality of layers 3107 to 3109 may comprise 1600 nodes, the layer 3107 may output a one-dimensional vector with a length of 1600 for the x axis, the layer 3108 may output a one-dimensional vector with a length of 1600 for the y axis, and the layer 3109 may output a one-dimensional vector with a length of 1600 for the z axis.

The fourth fully connected layer 314 may comprise a plurality of layers 3110 to 3112. The plurality of layers 3110 to 3112 may have one weight value and bias. An output of a corresponding layer, among the plurality of layers 3107 to 3109 is input to the plurality of layers 3110 to 3112. For example, an output of the layer 3107 may be input to the layer 3110. An output of the layer 3108 may be input to the layer 3111. An output of the layer 3109 may be input to the layer 3112.

Each of the plurality of layers 3110 to 3112 may have a predetermined number of nodes and/or may determine (e.g., may calculate) the input data as matrix to output data corresponding to the number of nodes. For example, each of the plurality of layers 3110 to 3112 may comprise 400 nodes, the layer 3110 may output a one-dimensional vector with a length of 400 for the x axis, the layer 3111 may output a one-dimensional vector with a length of 400 for the y axis, and the layer 3112 may output a one-dimensional vector with a length of 400 for the z axis.

The diagnosis model training unit 300 may normalize one or more outputs of the plurality of layers 3110 to 3112 and/or may flatten the output to one dimensional data to input to the layer 3113. For example, one-dimensional vector with a length of 1200 obtained by flattening one-dimensional vector with a length of 400 output from the layer 3110, one-dimensional vector with a length of 400 output from the layer 3111, and/or one-dimensional vector with a length of 400 output from the layer 3112 may be input to the layer 3113.

Each of the plurality of layers 3113 to 3115 may determine (e.g., may calculate) the input data as a matrix with a predetermined number of nodes to output data corresponding to the number of nodes. For example, the layer 3113 may comprise 256 nodes and output one-dimensional vector with a length of 256, the layer 3114 may comprise 256 nodes and output one-dimensional vector with a length of 256, and/or the layer 3115 may comprise 2 nodes and output one-dimensional vector with a length of 2.

Data output from the layer 3115 may indicate whether the noise point is faulty or normal. For example, if the data output from the layer 3115 is 1, it may indicate a faulty state of the decelerator and if the data is 0, it may indicate that the decelerator is normal.

The diagnosis model training unit 300 may train a method of predicting whether a region indicated by the plurality of noise point frequency data is faulty or normal by means of the fault diagnosis model 3000. The diagnosis model training unit 300 may input first data, among the plurality of noise point frequency data, to the fault diagnosis model 3000 to compare prediction data output from the layer 3115 and labeling data corresponding to first data, among the training dataset. The diagnosis model training unit 300 may train the plurality of fully connected layers 311 to 314 and the plurality of layers 3113 to 3115 to make a loss function value indicating the difference between the prediction data output from the layer 3115 and the labeling data minimum.

Further, the diagnosis model training unit 300 may input a test dataset including the actual frequency data 301 and the target noise point data 302 to the fault diagnosis model 3000 to test the fault diagnosis model 3000.

The diagnosis model training unit 300 may provide the fault diagnosis model 3000 generated by the deep learning to the controller 400. The storage unit 500 may store the trained fault diagnosis model 3000.

As described above, the controller 400 may provide the training dataset and test dataset to the diagnosis model training unit 300 and may be supplied with the fault diagnosis model 3000 from the diagnosis model training unit 300.

The controller 400 may input the target noise point data acquired from the noise prediction model 2000 to the trained fault diagnosis model 3000 to acquire fault information of a noise point indicating target noise point data.

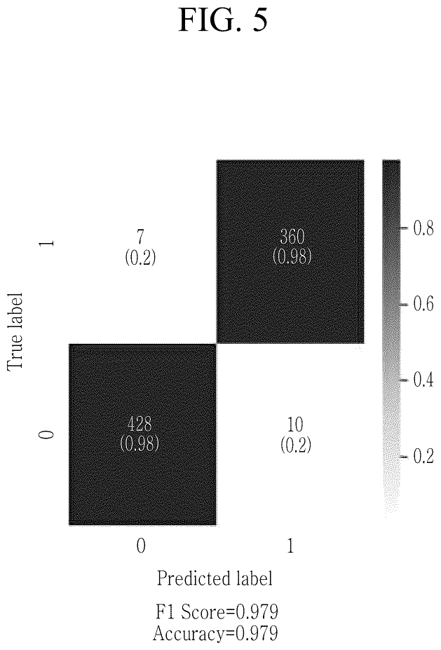

When the trained fault diagnosis model 3000 may receive the noise point data, the fault diagnosis model may predict the fault information of the noise point indicated by the noise point data. The storage unit 500 may store the fault information of the noise point indicated by the target noise point data. FIG. 5 is a confusion matrix for explaining an accuracy of a fault diagnosis model according to an example.

Referring to FIG. 5, a horizontal axis of the confusion matrix for the fault diagnosis model 3000 may indicate a label predicted by the fault diagnosis model 3000 and a vertical axis may indicate an actual label.

In the confusion matrix of FIG. 5, 1 may indicate a faulty state of the noise point and 0 may indicate a normal state.

Referring to FIG. 5, among a total of 805 data (=360+7+428+10) predicted by the fault diagnosis model 3000, data which is actually normal state 0 to be predicted as normal state 0 is 428 and data which is actually normal state 0 to be erroneously classified as a fault state 1 is 10. Accordingly, a probability of accurately classifying actually normal state (0) as a normal state (0) is 98% and a probability of erroneously classifying as a fault state 1 is 2%.

Further, 360 data may predict an actual fault state 1 as a faulty state 1 is and 7 data erroneously classifies an actually faulty state 1 as a normal state 0. Accordingly, a probability of correctly classifying the actual faulty state 1 as a faulty state 1 is 98% and a probability of erroneously classifying as the normal state 0 is 2%.

Referring to FIG. 5, an accuracy of the fault diagnosis model 3000 is (360+428)/(360+7+428+10)=97.9%, which is a high level. According to the example, the fault at the noise point is diagnosed using the fault diagnosis model 3000 with a significantly accurate level.

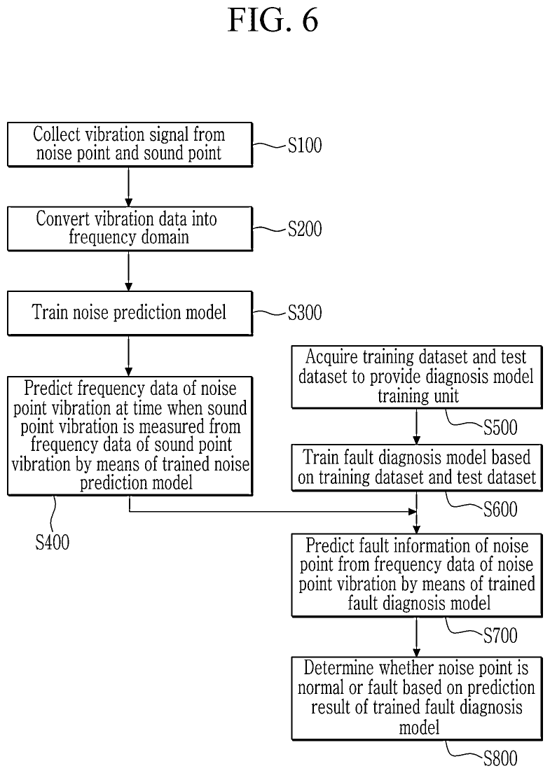

FIG. 6 is a flowchart of a fault diagnosis method according to an example.

Hereinafter, in the description of the fault diagnosis system 10, a description of the part overlapping the above-described description will be omitted. A fault diagnosis method to be described below may be performed by the at least one processor.

Referring to FIG. 6, sensors collect a vibration signal from a noise point or a sound point in S100.

The sensors may collect the vibration signal from at least one subpoint as well as the noise point and the sound point. The input unit 100 may acquire vibration signals collected from the sensors.

The input unit 100 may convert the vibration signals into a frequency domain in S200.

The prediction model training unit 200 may train the noise prediction model 2000 indicating a characteristic of a signal which changes from the sound point data to the noise point data by means of the plurality of convolutional layers in S300.

The controller 400 is provided with the trained noise prediction model 2000 from the prediction model training unit 200.

The input unit 100 may acquire the vibration signal in the sound point from the sensors. The input unit 100 may convert the acquired vibration signal into a frequency domain to provide the converted frequency domain to the controller 400.

The controller 400 may predict frequency data indicating a vibration signal of the noise point at a time when the vibration signal of the sound point is measured, from the frequency data corresponding to the vibration signal of the sound point by means of the trained noise prediction model 2000 in S400.

The controller 400 may acquire a training dataset and a test dataset from the storage unit 500 to provide the training dataset and the test dataset to the diagnosis model training unit 300 in S500.

The diagnosis model training unit 300 may train the fault diagnosis model 3000 based on the training dataset and the test dataset in S600.

The diagnosis model training unit 300 may provide the trained fault diagnosis model 3000 to the controller 400.

The controller 400 may predict fault information of the noise point indicated by the noise point data predicted in step S400 by the trained fault diagnosis model 3000 in S700.

The controller 400 may determine whether the noise point is normal or fault based on the prediction result of the trained fault diagnosis model 3000 in S800.

The present disclosure attempts to provide a noise point fault diagnosis method and a fault diagnosis system which predict a noise at the noise point based on vibration data of a noise which is sensed at a sound point.

According to a feature of the present disclosure, a fault diagnosis method performed by at least one processor may comprise generating noise point data by converting a vibration signal measured at a first time from a noise point in which a noise occurs into a frequency domain and generating sound point data which may convert the vibration signal measured from a sound point which senses the noise at the first time into a frequency domain, generating a noise prediction model which may generate frequency data indicating a vibration of the noise point from frequency data indicating a vibration of the sound point based on the noise point data and the sound point data by means of deep learning, acquiring a target vibration signal measured at a second time, from the sound point, predicting a target noise point data indicating vibration in the noise point from the target sound point data which may convert the target vibration signal into a frequency domain by means of the trained noise prediction model, and diagnosing a fault at the noise point based on the target noise point data.

The method further may comprise: generating subpoint data which may convert a vibration signal acquired from at least one subpoint between the noise point and the sound point into a frequency domain, and the generating of a noise prediction model may comprise training a first model which may generate frequency data indicating a vibration of the subpoint data from the frequency data indicating a vibration of the sound point based on the noise point data and the subpoint data, and training a second model which may generate frequency data indicating a vibration of the noise point from the frequency data indicating a vibration of the subpoint based on the subpoint data and the sound point data.

The noise prediction model may comprise a plurality of calculation blocks and at least one fully connected block, a kernel is applied to each of the plurality of calculation blocks, and the generating of the noise prediction model further may comprise determining a weight value and bias of the kernel.

The generating of the noise prediction model further may comprise calculating a loss function value by digitalizing a difference between a prediction value predicted by inputting the target sound point data to the noise prediction model and noise point data corresponding to the target sound point signal and training the plurality of calculation blocks to make the loss function value minimum.

The method further may comprise generating a fault diagnosis model which may predict the fault at the noise point from frequency data indicating the vibration of the noise point by means of the deep learning, based on a training dataset and a test dataset.

Each of the training dataset and the test dataset may comprise data which is labeled with fault information indicating whether the noise point is faulty in accordance with the noise point data, the generating of the fault diagnosis model may comprise training the fault diagnosis model based on the training dataset; and testing the fault diagnosis model based on the test dataset.

According to another feature of the present disclosure, a fault diagnosis system may comprise an input unit which may acquire a vibration signal measured at a first time from a noise point in which a noise occurs and a sound point which senses the noise and may acquire a target vibration signal measured at a second time from the sound point, a prediction model training unit which may generate and may train a noise prediction model which may generate frequency data indicating a vibration of a noise point from frequency data indicating a vibration of the sound point by means of the deep learning, and a controller which may provide noise point data which may convert a vibration signal measured at the first time from the noise point into a frequency domain and sound point data which may convert a vibration signal measured at the first time from the sound point into a frequency domain to the prediction model training unit, may receive the trained noise prediction model, may predict target noise point data indicating a vibration in the noise point at a second time from the target sound point data which may convert the target vibration signal into a frequency domain, by means of the trained noise prediction model, and diagnoses the fault at the noise point based on the target noise point data.

The input unit may acquire a vibration signal measured at the first time from at least one subpoint between the noise point and the sound point, the controller may generate subpoint data which may convert the vibration signal acquired from at least one subpoint into a frequency domain, the noise prediction model may comprise: a first model which may generate frequency data indicating a vibration of the subpoint data from frequency data indicating a vibration of the sound point, based on the noise point data and the subpoint data and a second model which may generate frequency data indicating a vibration of the noise point from frequency data indicating a vibration of the subpoint based on the subpoint data and the sound point data.

The noise prediction model may comprise a plurality of calculation blocks and at least one fully connected block, a kernel is applied to each of the plurality of calculation blocks, and the prediction model training unit may determine a weight value and bias of the kernel by means of the deep learning.

The prediction model training unit may determine (e.g., may calculate) a loss function value by digitalizing a difference between the prediction value predicted by inputting the target sound point data to the noise prediction model and noise point data corresponding to the target sound point signal and may train the plurality of calculation blocks to make the loss function value minimum.

The fault diagnosis system further may comprise a diagnosis model training unit which may generate and may train a fault diagnosis model which may predict the fault at the noise point from frequency data indicating a vibration of the noise point by means of the deep learning, based on the training dataset and the test dataset.

The training dataset and the test dataset may each comprise data which is labeled with the fault information indicating whether the noise point is faulty so as to correspond to the noise point data and the diagnosis model training unit may train the fault diagnosis model based on the training dataset and test the fault diagnosis model based on the test dataset.

According to the present disclosure, a fault of a vehicle driving system may be determined using a noise and vibration signals of a sound point which is apart from the noise point.

According to the present disclosure, a fault of a vehicle driving system may be more accurately determined from a vibration of a sound point using a deep learning model.

According to the present disclosure, even if it is difficult to install a sensor in a vehicle driving system in actual operation due to several reasons, it is possible to infer the degradation of the vehicle driving system using a driver's seat signal.

According to the present disclosure, it is possible to reduce the time and cost required for vehicle maintenance by accurately determining and handling the degradation of the vehicle driving system.

According to the present disclosure, consequently, the vehicle driver's driving sensibility can be improved and the satisfaction of customers using the vehicle can be improved.

While this disclosure includes descriptions of several practical examples, it is to be understood that the disclosed subject matter is not limited to the disclosed examples. On the contrary, it is intended to cover various modifications and equivalent arrangements included within the spirit and scope of the appended claims.

What is claimed is:

1. A method comprising:
generating, by a computing device, noise point data by converting a first vibration signal, measured at a noise point at a first time, into a frequency domain, wherein the first vibration signal is generated at the noise point;
generating sound point data by converting a second vibration signal measured at a sound point at the first time into a frequency domain, wherein the second vibration signal is based on propagation of the first vibration signal from the noise point to the sound point;
generating, based on deep learning using the noise point data and the sound point data, a noise prediction model configured to generate, using frequency data indicating a vibration at the sound point, frequency data indicating a vibration at the noise point;
predicting, based on the noise prediction model and based on a target vibration signal measured at the sound point at a second time, target noise point data indicating vibration at the noise point; and
diagnosing, based on the predicted target noise point data, a fault at the noise point.

2. The method of claim 1, further comprising:
generating subpoint data by converting a vibration signal acquired from at least one subpoint, between the noise point and the sound point, into a frequency domain,
wherein the generating the noise prediction model comprises:
training, based on the noise point data and the subpoint data a first model configured to generate, based on the frequency data indicating a vibration at the sound point, frequency data indicating a vibration at the subpoint; and
training, based on the subpoint data and the sound point data, a second model configured to generate, based on the frequency data indicating a vibration of the subpoint, frequency data indicating a vibration at the noise point.

3. The method of claim 2, wherein:
the noise prediction model comprises a plurality of calculation blocks and at least one fully connected block;
a kernel is applied to each of the plurality of calculation blocks; and
the generating the noise prediction model further comprises:
determining a weight value and bias of the kernel.

4. The method of claim 3, wherein:
the generating the noise prediction model further comprises:
calculating a loss function value by digitalizing a difference between:
a prediction value predicted by inputting target sound point data to the noise prediction model, and
noise point data corresponding to the target sound point data; and
training the plurality of calculation blocks to minimize the loss function value.

5. The method of claim 1, further comprising:
based on the deep learning, a training dataset and a test dataset, generating a fault diagnosis model configured to predict, based on frequency data indicating the vibration at the noise point, the fault at the noise point.

6. The method of claim 5, wherein each of the training dataset and the test dataset comprise data labeled with fault information indicating whether there is a fault at the noise point in accordance with the noise point data, and
wherein the generating of the fault diagnosis model comprises:
training, based on the training dataset, the fault diagnosis model; and
testing, based on the test dataset, the fault diagnosis model.

7. A fault diagnosis system, comprising:
an input unit configured to receive:
a first vibration signal measured at a noise point at a first time, wherein the first vibration signal is generated at the noise point,
a second vibration signal measured at a sound point at the first time, wherein the second vibration signal is based on propagation of the first vibration signal from the noise point to the sound point, and
a target vibration signal measured at the sound point at a second time;
a prediction model training unit configured to, via deep learning, generate and train a noise prediction model configured to generate, based on frequency data indicating a vibration at the sound point, frequency data indicating a vibration at the noise point; and
a controller configured to:
provide noise point data and sound point data to the prediction model training unit, wherein the noise point data is generated by converting the first vibration signal into a frequency domain and the sound point data is generated by converting the second vibration signal into the frequency domain;
receive the trained noise prediction model;
predict, based on the trained noise prediction model and on target sound point data generated by converting the target vibration signal into a frequency domain, target noise point data indicating a vibration at the noise point at the second time; and
diagnose, based on the target noise point data, a fault at the noise point.

8. The fault diagnosis system of claim 7, wherein:
the input unit is configured to acquire a third vibration signal measured at the first time at at least one subpoint between the noise point and the sound point,
the controller is configured to generate subpoint data by converting the third vibration signal into the frequency domain,
the noise prediction model comprises:
a first model, based on the noise point data and the subpoint data, configured to generate, based on frequency data indicating a vibration at the sound point, frequency data indicating a vibration at the subpoint; and
a second model, based on the subpoint data and the sound point data, configured to generate frequency data indicating a vibration of the noise point from frequency data indicating a vibration of the subpoint.

9. The fault diagnosis system of claim 8, wherein:
the noise prediction model comprises a plurality of calculation blocks and at least one fully connected block,
a kernel is configured to be applied to each of the plurality of calculation blocks, and
the prediction model training unit is configured to determine, based on the deep learning, a weight value and bias of the kernel.

10. The fault diagnosis system of claim 9, wherein:
the prediction model training unit is configured to:
calculate a loss function value by digitalizing a difference between:
a prediction value predicted by inputting the target sound point data to the noise prediction model; and
noise point data corresponding to the target sound point data; and
train the plurality of calculation blocks to minimize the loss function value.

11. The fault diagnosis system of claim 7, further comprising:
a diagnosis model training unit configured to, based on a training dataset and a test dataset and via deep learning, generate and train a fault diagnosis model configured to predict, based on frequency data indicating a vibration at the noise point, the fault at the noise point.

12. The fault diagnosis system of claim 11, wherein:
the training dataset and the test dataset each comprise data labeled with fault information, indicating whether there is a fault at the noise point, corresponding to the noise point data; and
the diagnosis model training unit is configured to:
train, based on the training dataset, the fault diagnosis model; and
test, based on the test dataset, the fault diagnosis model.
